(19) United States
(12) Patent Application Publication
(10) Pub. No.: US 2007/0018083 A1
(43) Pub. Date: Jan. 25, 2007

(54) Structural health monitoring layer having distributed electronics

(75) Inventors: Amrita Kumar, Santa Clara, CA (US); Xinlin Qing, Cupertino, CA (US); Shawn J. Beard, Livermore, CA (US); Chang Zhang, Santa Clara, CA (US); Zengpin Yu, Palo Alto, CA (US); Irene Li, Stanford, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Acellent Technologies, Inc.

(21) Appl. No.: 11/453,184

(22) Filed: Jun. 13, 2006

Related U.S. Application Data
(60) Provisional application No. 60/690,337, filed on Jun. 13, 2005.

(51) Int. Cl. G01J 1/04; G01J 1/42; G01B 7/16

(52) U.S. Cl. 250/227.14; 73/768

(57) ABSTRACT

A sensor array embedded within a flexible layer. The sensors, which can be transducers, are controlled by local electronics also embedded within the flexible layer. The invention includes numerous different arrangements of these electronic controllers and their associated transducers. For example, each transducer can have its own controller embedded nearby. Alternatively, one controller can control a number of transducers, and can therefore be embedded in various configurations proximate to one or more of the transducers it controls. The controllers can include various components that impart other advantages, such as wireless transceivers for reducing the number of wires needed within the flexible layer, and local processors for reducing or eliminating the need for a remote data processor.

This application claims priority to U.S. Provisional Patent Application No. 60/690,337, filed on Jun. 13, 2005, the disclosure of which is hereby incorporated by reference in its entirety and for all purposes.

### BRIEF DESCRIPTION OF THE INVENTION

The present invention relates generally to structural health monitoring. More specifically, the present invention relates to structural analysis layers having distributed electronics.

### BACKGROUND OF THE INVENTION

The diagnostics and monitoring of structures, such as that carried out in the structural health monitoring field, are often accomplished by employing arrays of sensing elements. While many advances have been made, the field continues to be challenged by a need to for increased accuracy and performance from its structural health monitoring systems, leading many to employ ever greater numbers of sensors/actuators. However, the larger the number of these elements, the greater the number of wires required for their operation.

Because individual sensing elements must often be placed separately, affixing a large array of such sensing elements can be tedious and time consuming. In addition, as each individual sensing element can require one or, commonly, multiple wires, large arrays of sensing elements can require a large number of individual wires, which may be difficult to handle and place. The securing of such large numbers of wires can often be painstaking and time consuming, as well. It is therefore desirable to combine these large numbers of elements, and their wires, together in such a manner that the abovementioned difficulties are avoided, or at least reduced.

Additionally, the demand for improved performance from structural health monitoring sensor arrays has led to the use of larger arrays. This in turn has led to greater signal noise and interference problems, especially in the monitoring of large structures where the controller and array may be separated by large distances. It is therefore further desirable to combine structural health monitoring sensor elements and their associated electronics in such a way as to improve performance and reduce detrimental effects such as noise and interference, while also reducing the difficulty in affixing such complicated systems to the structures they monitor.

### SUMMARY OF THE INVENTION

The invention can be implemented in numerous ways, including as a system, device, or apparatus. Several embodiments of the invention are discussed below.

In one embodiment, a structural health monitoring system comprises a flexible substrate configured for attachment to a structure, a plurality of sensors affixed to and spatially distributed upon the flexible substrate, and at least one controller affixed to the flexible substrate and in electronic communication with at least one sensor of the plurality of sensors. The at least one controller is configured to control a function of the at least one sensor.

In another embodiment, a structural health monitoring system comprises a flexible substrate configured for attachment to a body, a plurality of sensors affixed to and spatially distributed upon the flexible substrate, the plurality of sensors configured for monitoring the structural health of the body, and a distributed control network having elements distributed across the flexible substrate. The control network is configured to govern functions of the plurality of sensors so as to control the monitoring of the structural health of the body.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention, together with further objects and advantages thereof, may best be understood by reference to the following description taken in conjunction with the accompanying drawings in which:

FIG. 1A illustrates a top view of a sensing layer manufactured in accordance with embodiments of the present invention;

FIGS. 1B-1C illustrate block and circuit diagrams, respectively, describing elements of a sensing layer and their operation;

FIG. 2 illustrates a sensing layer having a controller associated with each transducer, in accordance with an embodiment of the present invention;

FIG. 3 illustrates a sensing layer having a controller associated with a group of transducers and placed near the transducer group, in accordance with a further embodiment of the present invention;

FIG. 4 illustrates a sensing layer having controllers associated with groups of transducers and placed within the transducer groups, in accordance with a still further embodiment of the present invention;

FIG. 5 illustrates a sensing layer having controllers associated with interleaved groups of transducers, in accordance with a still further embodiment of the present invention.

Like reference numerals refer to corresponding parts throughout the drawings. Also, it is understood that the depictions in the figures are diagrammatic and not necessarily to scale.

### DETAILED DESCRIPTION OF EMBODIMENTS OF THE INVENTION

In one embodiment of the invention, a sensor array is embedded within a flexible layer, which can then be attached to a structure and employed to monitor its structural health. The sensor array employs transducers, capable of acting as both passive sensors and active actuators. These transducers are controlled by local electronics also embedded within the flexible layer. The invention includes numerous different arrangements of these electronic controllers and their associated transducers. For example, each transducer can have its own controller embedded nearby. Alternatively, one controller can control a number of transducers, and can therefore be embedded in various configurations proximate to one or more of the transducers it controls. The embedding of controllers local to the transducers they control generates a number of advantages. As one example, the close proximity of the controllers to their sensors tends to reduce interference and signal noise, yielding cleaner and more reliable data. In addition, the controllers can include various components that impart other advantages, such as wireless transceivers for reducing the number of wires needed within the flexible layer, and local processors for reducing or eliminating the need for a remote data processor.

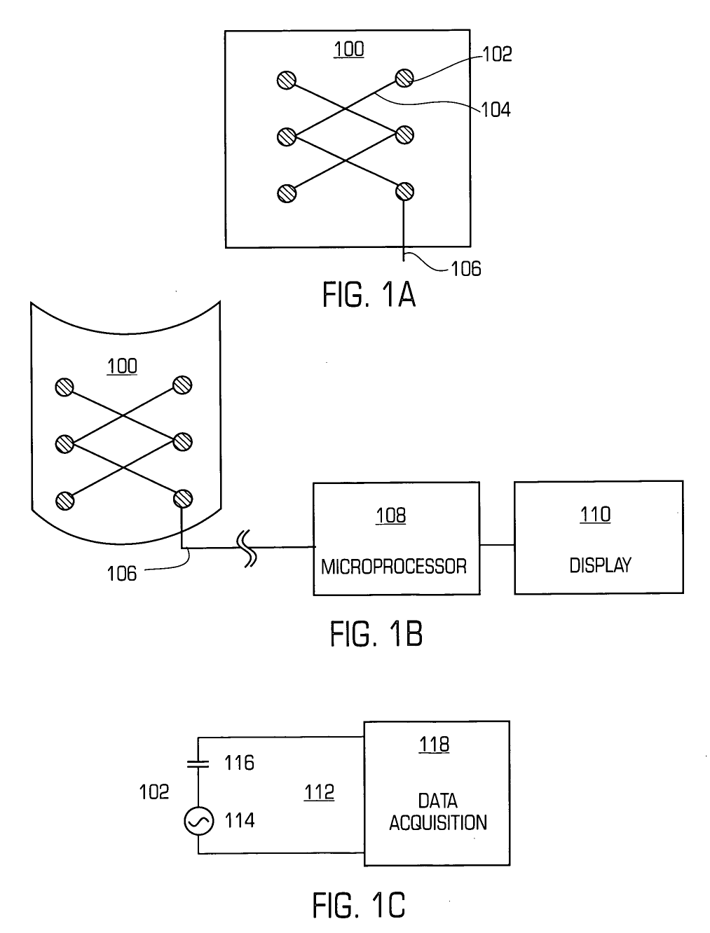

For ease of installation, the sensor network can be placed on a flexible dielectric substrate to form a diagnostic layer. FIG. 1A illustrates such a flexible diagnostic layer for use in accordance with embodiments of the present invention. A diagnostic layer 100 is shown, which contains an array of transducers 102. As above, the transducers 102 can act as sensors capable of receiving signals used in structural health monitoring such as stress waves, and also as actuators capable of generating vibration, and are connected to conductive traces 104. The traces 104 connect (or interconnect, if necessary) transducers 102 to one or more output leads 106 configured for connection to a processor or other device capable of analyzing the data derived from the sensors 102. Accordingly, the transducers 102 can both passively generate electrical signals in response to stress waves, and actively generate stress waves in a structure when a voltage is applied to them.

The diagnostic layer 100 and its operation are further described in U.S. Pat. No. 6,370,964 to Chang et al., which is hereby incorporated by reference in its entirety and for all purposes. Construction of the diagnostic layer 100 is also explained in U.S. patent application Ser. No. 10/873,548, filed on Jun. 21, 2004, which is also incorporated by reference in its entirety and for all purposes. It should be noted that the present invention is not limited to the embodiments disclosed in the aforementioned U.S. patent application Ser. No. 10/873,548, but instead encompasses the use of flexible sensor layers having any configuration.

For illustration, FIG. 1B further describes aspects of the operation of the diagnostic layer 100. In operation, the output leads 106 are electrically connected to an analysis unit such as a microprocessor 108, suitable for analyzing signals from the sensors 102. In certain embodiments, the flexible layer 100 is first attached to a structure in a manner that allows the sensing elements 102 to detect quantities related to the health of the structure. For instance, the sensors 102 can be sensors configured to detect stress waves propagated within the structure, and emit electrical signals accordingly. The microprocessor 108 then analyzes these electrical signals to assess various aspects of the health of the structure. For instance, detected stress waves can be analyzed to detect crack propagation within the structure, delamination within composite structures, or the likelihood of fatigue-related failure. Quantities such as these can then be displayed to the user via display 110.

In one embodiment, the sensors 102 can be piezoelectric transducers capable of reacting to a propagating stress wave by generating a voltage signal. Analysis of these signals highlights properties of the stress wave, such as its magnitude, propagation speed, frequency components, and the like. Such properties are known to be useful in structural health monitoring. FIG. 1C illustrates a circuit diagram representation of such an embodiment. This embodiment can often be represented as a circuit 112, where each sensor 102 is represented as a voltage source 114 in series with a capacitor 116 (impedance circuitry) used to adjust signal strength. This pair is in electrical contact with a data acquisition unit 118, such as a known data acquisition card employed by microprocessors 108 (the data acquisition unit 118 can be thought of as a component interface to the microprocessor 108). Propagating stress waves induce the sensor 102 to emit a voltage signal that is recorded by the data acquisition unit 118, where it can be analyzed to determine the health of the structure in question. These piezoelectric transducers can also act as actuators, converting an applied voltage to a stress wave signal. In another embodiment, the sensors 102 can be known fiber optic sensors that convert stress waves to optical signals. The sensors 102 can also be other known elements, such as strain gauges, temperature sensors, or miniature actuators/sensors fabricated according to Micro-Electro-Mechanical Systems (MEMS) techniques. Indeed, for sensors 102, the invention encompasses the use of any sensor or actuator amenable to affixing within a flexible layer for placement on a structure.

The data acquisition unit 118 and other electronics are often located remotely from the diagnostic layer 100 and sensors 102. As one or more (and typically many) wires must usually be run between the electronics and the sensors 102, such systems often are vulnerable to electrical interference and other disadvantages, as described above. Accordingly, FIG. 2 illustrates a diagnostic layer 200 configured similar to diagnostic layer 100, with transducers 202 spatially distributed along the layer 200. However, instead of a single set of remotely-located electronics, the layer 200 has a controller 204 for each transducer 202. Each controller 204 is affixed to the layer 200 in a position relatively close to its associated transducer 202, so that any necessary connecting wires are relatively short, thus avoiding signal noise and most electrical interference. In this configuration, the controllers 204 act as a distributed local control network, controlling the operation of each transducer 202 from within the layer 200 itself, without the drawbacks of a central, remotely located controller. In this manner, the local control network can govern the operation of the transducers 202, providing control of the structural health monitoring process from the layer 200 itself.

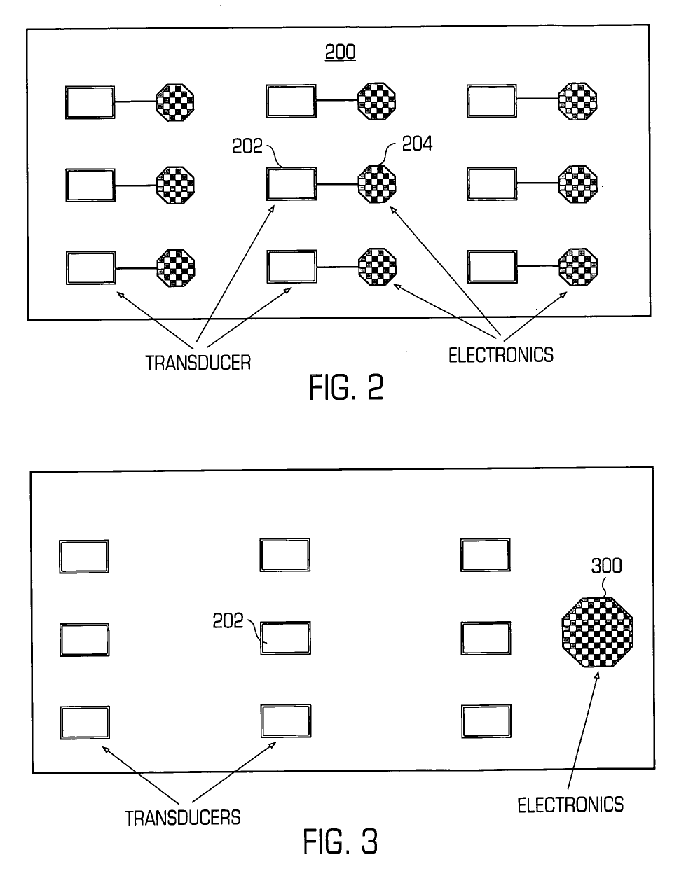

FIG. 3 illustrates a further embodiment of the present invention, in which each controller 300 controls a group of transducers 202, and is affixed to the layer 200 close to the transducers 202 that it controls. Connecting wires (not shown) connect the controller 300 to each of the transducers 202 that it controls. Similar to FIG. 2, the controllers 300 of FIG. 3 are distributed across the layer 200, thus forming a distributed control network. However, here each controller 300 controls a “cluster” of transducers 202, instead of a single element. To reduce noise and interference effects, the controllers 300 are affixed to the layer 200 relatively close to the clusters of transducers 202 that they control, as shown.

FIG. 4 illustrates another embodiment of the present invention. Like the embodiment of FIG. 3, a group 400 of transducers 202 is controlled by a single controller 402. However here, each controller 402 is affixed to the layer 200 within the area defined by its associated group 400. That is, each controller 402 is located within the area defined by the sensors that it controls. Like the embodiment of FIG. 3, placement of the controllers 402 within the areas defined by the groups 400 that they control helps ensure shorter connecting wires (not shown), thus reducing noise and interference.

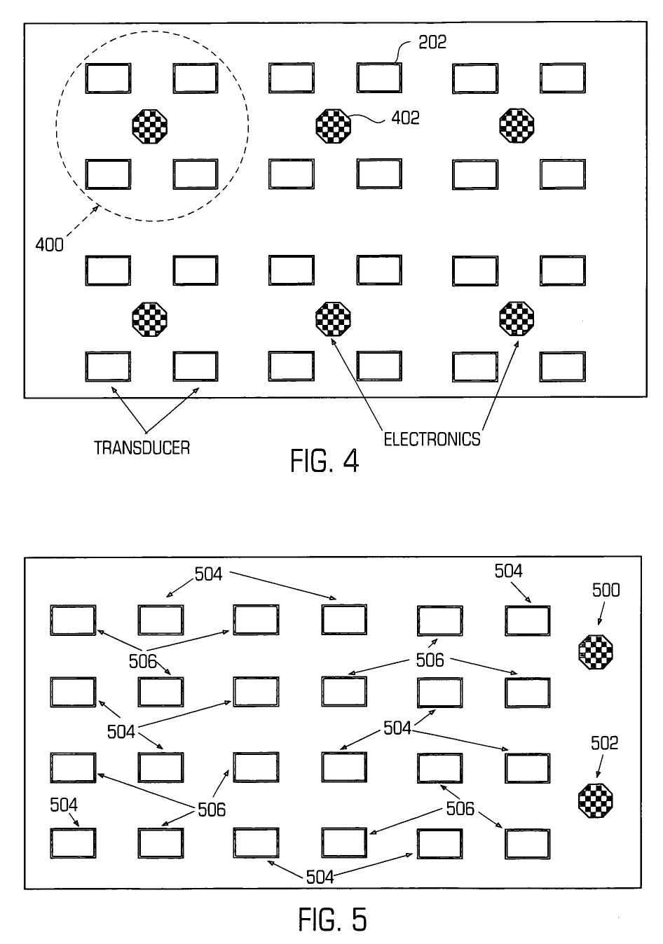

FIG. 5 illustrates another embodiment of the present invention. Here, each controller controls a group of sensors, and neighboring groups are “interleaved,” with a given area containing sensors from more than one group. For example, as shown, controller 500 controls, and is connected to, a group of transducers 504. Similarly, controller 502 controls, and is connected to, a different group of transducers 506. Within the same area, transducers 504, 506 from each group are alternately placed, so that the same area contains sensing elements from both groups. In the configuration shown, each row or column has sensors that alternate between transducers 504 from one group, and transducers 506 from the other. However, the invention includes any such interleaving, and not just those configurations involving alternating patterns of transducers 504, 506. Also, transducers 504, 506 can be the same type of transducers, but used for different purposes. For example, transducers 504 can be used as actuators, while transducers 506 can be used as sensors. Transducers 504, 506 can also be different types of transducers used for different purposes. For example, transducers 504 can be temperature sensors used to measure temperature distribution, while transducers 506 can be piezoelectric sensors used to detect structural damage. Such configurations allow for layers 200 having greater capabilities and more flexibility of function than those layers involving only one type of transducer.

It should be noted that the invention is not limited to the embodiments described above. Specifically, the controllers described above can be any electronic component, or collection thereof, suitable for governing or controlling one or more functions of a sensing or actuating element. In this aspect, the invention includes any control network whose elements can be distributed across a flexible layer while maintaining the ability to control any function of a number of sensors or actuators. For example, the controllers can be simple processors that control the application of power to an actuator in response to an initiating signal, so as to direct the actuator to generate a stress wave at certain times. An equally simple processor can be set up to gather and process the data from a sensing element. The controllers can also contain additional components for executing more complex functions, such as switching between different actuators and sensors within the groups of transducers they control. For example, the controllers can include memory that stores a signal profile, and instructions for inducing a transducer to produce a stress wave signal having that profile. Other components can also allow the controllers to process data from multiple sensors simultaneously or control several actuators at once, as well as execute more complex data analysis such as filtering, signal conditioning, and mathematical operations and algorithms for structural analysis methods. Likewise, the controllers can employ known components such as wireless transceivers, that allow each controller to wirelessly communicate with remote devices, eliminating the need for wires to connect the controllers to those remote devices and further simplifying the layout and maintenance of layers 200. The components described above are known, and include processors, local memory for storing data and instructions for carrying out the tasks described above, switching circuits, frequency filters, and wireless transceivers.

It should also be noted that the invention encompasses other configurations of the apparatuses shown. For instance, while FIGS. 2-5 show transducers distributed across a layer 202 in a regular matrix or array pattern (i.e., rows and columns of transducers), the invention is not limited to these distributions, and can encompass any shape layer 202, and any distribution of elements and controllers. Furthermore, as the layers 202 are flexible, it is often preferable to fabricate the controllers of known flexible electronic components. However, the invention encompasses the use of various relatively rigid electronic components when, for example, they offer a price or performance advantage over corresponding flexible components.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, each processor can control one or more sensing/actuating elements, and can be placed at various locations proximate to the elements they control. In addition, each controller can be equipped with a processor, local memory, and any other components it needs to carry out various functions, including but not limited to data collection, conditioning, and analysis, signal generation, and wireless communication. These components can include filters, switches, and wireless transceivers. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A structural health monitoring system, comprising:
a flexible substrate configured for attachment to a structure;
a plurality of sensors affixed to and spatially distributed upon the flexible substrate; and
at least one controller affixed to the flexible substrate and in electronic communication with at least one sensor of the plurality of sensors, the at least one controller configured to control a function of the at least one sensor.

2. The structural health monitoring system of claim 1, wherein the at least one controller further comprises a plurality of controllers each in electronic communication with, and configured to control the function of, one sensor of the plurality of sensors.

3. The structural health monitoring system of claim 1, wherein the at least one controller further comprises a controller in electronic communication with, and configured to control the function of, each sensor of the plurality of sensors.

4. The structural health monitoring system of claim 1, wherein the plurality of sensors is divided into multiple sensor groups, and wherein the at least one controller further comprises a plurality of controllers each in electronic communication with a separate one of the sensor groups, and configured to control the function of its associated sensor group.

5. The structural health monitoring system of claim 4, wherein each sensor group is spatially distributed within an area of the flexible substrate, and wherein each controller is affixed to the flexible substrate within the area of its associated sensor group.

6. The structural health monitoring system of claim 4, wherein each controller is affixed to the flexible substrate proximate to at least one sensor of its associated sensor group.

7. The structural health monitoring system of claim 1 wherein the flexible substrate is a flexible printed circuit.

8. The structural health monitoring system of claim 1 wherein each sensor of the plurality of sensors is a piezoelectric transducer.

9. The structural health monitoring system of claim 1 wherein at least one sensor of the plurality of sensors is a strain gage.

10. The structural health monitoring system of claim 1 wherein at least one sensor of the plurality of sensors is a fiber optic transducer.

11. The structural health monitoring system of claim 1 wherein at least one sensor of the plurality of sensors is a MEMS sensor.

12. The structural health monitoring system of claim 1 wherein at least one sensor of the plurality of sensors is a temperature sensor.

13. The structural health monitoring system of claim 1 wherein the plurality of sensors is generally spatially distributed as a matrix.

14. The structural health monitoring system of claim 1 wherein the at least one controller further comprises a switch circuit configured to switch the electronic communication between sensors of the plurality of sensors.

15. The structural health monitoring system of claim 1 wherein the at least one controller further comprises a memory configured to store at least one of a signal profile and instructions for carrying out the control of the function of the at least one sensor, and a processor for executing the instructions.

16. The structural health monitoring system of claim 14 wherein the instructions include instructions for carrying out a plurality of tasks, the plurality of tasks including at least one of:
acquisition of data from the at least one sensor;
manipulation of data acquired from the at least one sensor;
generation of signals from the at least one sensor;
transmission of wireless signals; and
reception of wireless signals.

17. The structural health monitoring system of claim 1 wherein the at least one controller further comprises a plurality of flexible electronic devices.

18. A structural health monitoring system, comprising:
a flexible substrate configured for attachment to a body;
a plurality of sensors affixed to and spatially distributed upon the flexible substrate, the plurality of sensors configured for monitoring the structural health of the body; and
a distributed control network having elements distributed across the flexible substrate, the control network configured to govern functions of the plurality of sensors so as to control the monitoring of the structural health of the body.

19. The structural health monitoring system of claim 18, wherein the distributed control network further comprises a plurality of controllers each in electronic communication with, and configured to control a function of, one sensor of the plurality of sensors.

20. The structural health monitoring system of claim 18, wherein the distributed control network further comprises a controller in electronic communication with, and configured to control a function of, each sensor of the plurality of sensors.

21. The structural health monitoring system of claim 18, wherein the plurality of sensors is divided into multiple sensor groups, and wherein the distributed control network further comprises a plurality of controllers each in electronic communication with a separate one of the sensor groups, and configured to control a function of its associated sensor group.

22. The structural health monitoring system of claim 21, wherein each sensor group is spatially distributed within an area of the flexible substrate, and wherein each controller is affixed to the flexible substrate within the area of its associated sensor group.

23. The structural health monitoring system of claim 21, wherein each controller is affixed to the flexible substrate proximate to at least one sensor of its associated sensor group.

24. The structural health monitoring system of claim 18 wherein the flexible substrate is a flexible printed circuit.

25. The structural health monitoring system of claim 18 wherein each sensor of the plurality of sensors is a piezoelectric transducer.

26. The structural health monitoring system of claim 18 wherein at least one sensor of the plurality of sensors is a strain gage.

27. The structural health monitoring system of claim 18 wherein at least one sensor of the plurality of sensors is a fiber optic transducer.

28. The structural health monitoring system of claim 18 wherein at least one sensor of the plurality of sensors is a MEMS sensor.

29. The structural health monitoring system of claim 18 wherein at least one sensor of the plurality of sensors is a temperature sensor.

30. The structural health monitoring system of claim 18 wherein the plurality of sensors is generally spatially distributed as a matrix.

31. The structural health monitoring system of claim 18 wherein at least one of the elements is a switch circuit configured to switch an electrical connection of the distributed control network between sensors of the plurality of sensors.

32. The structural health monitoring system of claim 18 wherein at least one of the elements further comprises a memory configured to store at least one of a signal profile and instructions for controlling a function of at least one sensor of the plurality of sensors, and a processor for executing the instructions.

33. The structural health monitoring system of claim 21 wherein the instructions include instructions for carrying out a plurality of tasks, the plurality of tasks including at least one of:
acquisition of data from the at least one sensor;
manipulation of data acquired from the at least one sensor;
generation of signals from the at least one sensor;
transmission of wireless signals; and
reception of wireless signals.

34. The structural health monitoring system of claim 18 wherein the elements further comprise a plurality of flexible electronic devices.
